(19) United States
(12) Patent Application Publication
(10) Pub. No.: US 2013/0215635 A1
(43) Pub. Date: Aug. 22, 2013

(54) AUTOMOTIVE HEADLAMP HAVING A BEAM CHANGING ASSEMBLY

(71) Applicants: Ronald E. Boyd, JR., Chichester, NH (US); Lawrence M. Rice, Hillsboro, NH (US); Howard Eng, Hancock, NH (US); Thomas Tessnow, Weare, NH (US)

(72) Inventors: Ronald E. Boyd, JR., Chichester, NH (US); Lawrence M. Rice, Hillsboro, NH (US); Howard Eng, Hancock, NH (US); Thomas Tessnow, Weare, NH (US)

(73) Assignee: OSRAM SYLVANIA Inc., Danvers, MA (US)

(21) Appl. No.: 13/402,453

(22) Filed: Feb. 22, 2012

(51) Int. Cl. B60Q 1/076; B60Q 1/06

(52) U.S. Cl. 362/518; 362/519

(57) ABSTRACT

An automotive headlamp (12) having a light engine (20) including a solid-state light source (32) emitting visible light and a reflector (26) configured to receive and reflect light emitted by the solid-state light source (32). The automotive headlamp (12) further includes an adjustment unit (22) having a displacement member (40) coupled to the solid-state light source (32) and adapted to displace the solid-state light source (32) relative to the reflector (26) between a first position, wherein the headlamp (12) projects a low-beam pattern, and a second position, wherein the headlamp (12) projects a high-beam pattern.

### CROSS REFERENCE TO RELATED APPLICATIONS

N/A

1. Technical Field

The present disclosure relates to lighting systems, and, more particularly, to a bi-functional automotive headlamp having a beam changing assembly.

2. Background

Lighting systems are well-known and are used in a wide variety of applications, including automotive applications. Generally, an automotive headlamp, for example, includes a light source and optical components, such as lenses and reflectors to collect and shape light emitted by the light source and to project the resulting beam pattern forward of the vehicle in a light distinct pattern. It may be preferred that a single automotive headlamp system be capable of projecting more than one beam pattern (i.e. a bi-functional headlamp). For example, a headlamp may emit light in a low-beam mode in which light is generally emitted below the horizon. The headlamp may also emit light in a high beam mode in which light is generally emitted above and below the horizon.

Some bi-functional headlamp systems include multiple light sources for the low and high beam modes. For example, some filament headlamp systems include multiple filaments: one filament for the low beam function, and another filament for the high beam function. Similarly, some light emitting diode (LED) headlamp systems include multiple strings of LED modules or chips; one string of LEDs for the low beam function, and another string of LEDs for the high beam function. Some headlamp systems further include a mechanism for adjusting the light sources and/or other components of the headlamp, such as the reflector, to produce the low beam and high beam functions. Additionally, some bi-functional headlamp systems utilize a single shutter or light shield to selectively block a portion of the light from a single light source to provide a low beam pattern and, to provide a high beam pattern, the shielded light is added to the beam by retraction of the shield. Examples of such headlamps may be found in U.S. Pat. No. 5,567,032 (Heizmann); U.S. Pat. No. 5,911,502 (Zillgitt et al.); U.S. Pat. No. 5,971,574 (Taniuchi et al.); U.S. Pat. No. 6,043,614 (Tessnow et al.); U.S. Pat. No. 6,552,493 (Yen); U.S. Pat. No. 6,953,274 (Rice); U.S. Pat. No. 7,156,544 (Ishida); U.S. Pat. No. 7,290,907 (Kovach); U.S. Pat. No. 7,837,367 (Huang et al.); U.S. Patent Pub. No. 2002/0039289 (Kinouchi); U.S. Patent Pub. No.2005/0088853 (Yatsuda et al.); U.S. Patent Pub. No. 2008/0055918 (Mascadri); and European Patent No. EP 0982189 (Taniuchi et al.).

One limitation to these types of known bi-functional headlamp systems is the cost associated with having multiple light sources provided in the bi-functional headlamp. In the case of current LED headlamp systems, for example, the large number of required LEDs increases the amount of heat generated, thus necessitating one or more fans, air ducts, and the like to ensure that the operating temperature of the LEDs is maintained within an acceptable range. Consequently, numerous components are necessary which results in a very expensive and complex headlamp which requires tight manufacturing tolerances to properly aim the multiple, discrete light sources.

### BRIEF DESCRIPTION OF THE DRAWINGS

Reference should be made to the following detailed description which should be read in conjunction with the following figures, wherein like numerals represent like parts:

FIG. 1 illustrates a block diagram of one embodiment of a lighting system consistent with the present disclosure;

FIG. 2 illustrates a perspective view of a light module of the lighting system of FIG. 1 consistent with the present disclosure;

FIG. 3 illustrates a front view of a portion of one embodiment of a light module of the lighting system of FIG. 1 consistent with the present disclosure;

FIG. 4A illustrates a side cross-sectional view of the light module of FIG. 3 in a low beam mode;

FIG. 4B illustrates a perspective view of the light module of FIG. 3 in a low beam mode;

FIG. 5A illustrates a side cross-sectional view of the light module of FIG. 3 in a high beam mode;

FIG. 5B illustrates a perspective view of the light module of FIG. 3 in a high beam mode;

FIG. 6 illustrates a front view of a portion of another embodiment of a light module of the lighting system of FIG. 1 consistent with the present disclosure;

FIG. 7A illustrates a top cross-sectional view of the light module of FIG. 6 in a low beam mode;

FIG. 7B illustrates a perspective view of the light module of FIG. 6 in a low beam mode;

FIG. 8A illustrates a top cross-sectional view of the light module of FIG. 6 in a high beam mode;

FIG. 8B illustrates a perspective view of the light module of FIG. 6 in a high beam mode;

FIG. 9A illustrates a front view of a portion of another embodiment of a light module of the lighting system of FIG. 1 in a low beam mode;

FIG. 9B illustrates a side cross-sectional view of the light module of FIG. 9A in a low beam mode;

FIG. 10A illustrates a front view of a portion of the light module of FIG. 9A in a high beam mode; and

FIG. 10B illustrates a side cross-sectional view of the light module of FIG. 9A in a high beam mode.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION

By way of an overview, one aspect consistent with the present disclosure may feature a vehicle lighting system including a bi-functional headlamp. The headlamp includes a single light engine including a solid-state light source (i.e. a single string of one or more LEDs) emitting visible light and a reflector configured to receive and reflect light emitted by the solid-state light source. The headlamp further includes an adjustment unit having a displacement member coupled to the solid-state light source. The adjustment unit is adapted to displace the solid-state light source relative to the reflector between a first position, wherein the light from the solid-state light source is directed towards a first portion of the reflector, and a second position, wherein the light from the solid-state light source is directed towards a second portion of the reflector. When the solid-state light source is in the first position, the headlamp functions in a first lighting mode, such as low beam mode, in which light is generally emitted below or at and below a horizontal plane. When the solid-state light source is in the second position, the headlamp functions in a second lighting mode, such as high-beam mode, in which light is generally emitted both above and below the horizontal plane. When the light is directed below or at and below the horizontal plane, it is generally emitted in a direction directed below or at and below the horizon, which is a virtual plane located far ahead of the vehicle.

A headlamp consistent with the present disclosure includes a single light engine including a solid-state light source, such as a single string of one or more LEDs. The single string of LEDs is adapted to move between a first position to provide a low-beam light pattern and a second position to provide a high-beam light pattern from the headlamp. As such, a headlamp consistent with the present disclosure is configured to provide both low and high beam modes from a single string of LEDs, as opposed to multiple strings of LEDs, thereby reducing costs. In a string of multiple LEDs, the LEDs illuminate together.

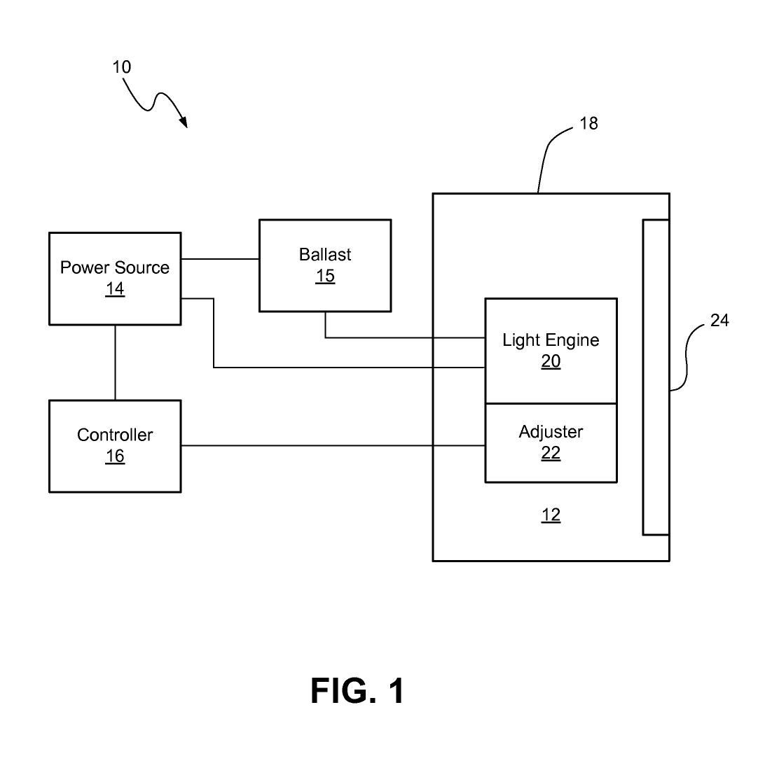

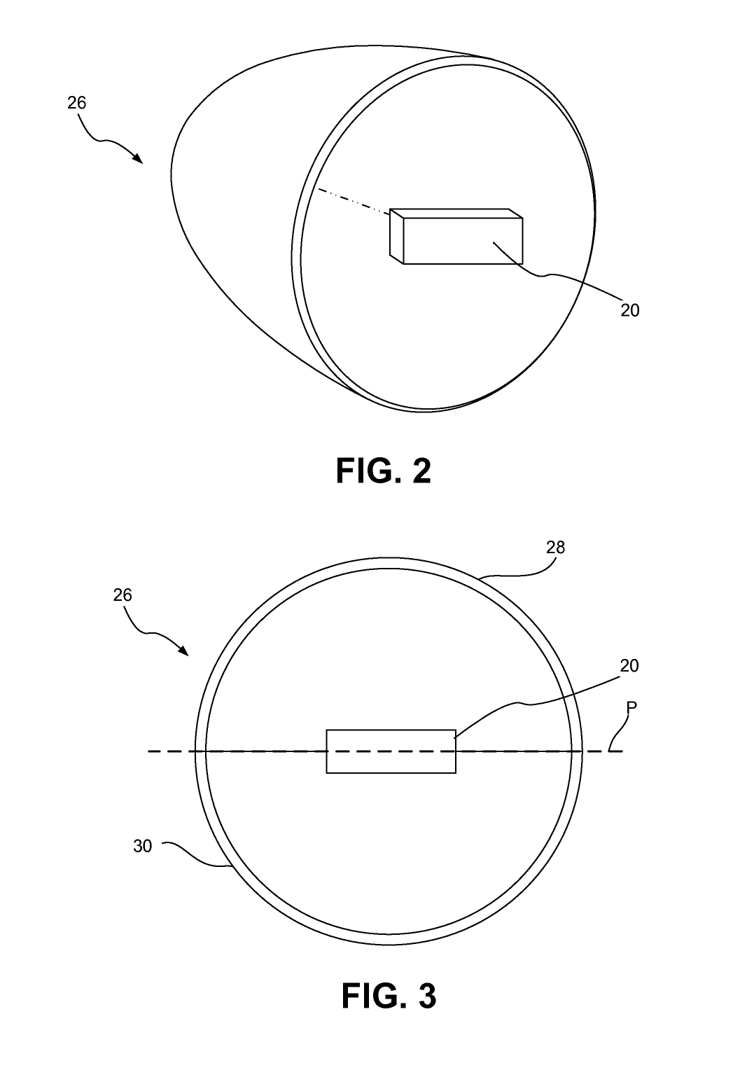

Turning now to FIG. 1, one embodiment of a lighting system 10 consistent with the present disclosure is generally illustrated. The lighting system 10 includes a light module 12, a power source 14, and a controller 16. In the illustrated embodiments described herein, the light module 12 includes an automotive headlamp or headlight. As such, the light module 12 is hereinafter referred to as “headlamp 12”. The headlamp 12 includes a housing 18, a single light engine 20, an adjustment unit 22 coupled to the light engine 18, and a reflector 26 (shown in FIG. 2). The housing 18 is configured to receive at least a portion of the light engine 20 and/or adjustment unit 22. The housing 18 may also include one or more outer lenses 24 as described in greater detail herein.

The headlamp 12 receives an electrical input from the power source 14, for example, to energize the light engine 20 and/or the adjustment unit 22. The power source 14 comprises a DC and/or AC power source, and may include one or more inverters, converters, and/or power conditioners. Optionally, one or more ballast circuits 15 receive an electrical input from the power source 14 and convert it to a stable output for driving the headlamp 12. One or more of the ballast circuits 15 may be positioned remotely from the headlamp 12 or may be integral with or coupled directed to the housing 18 of the headlamp 12. The controller 16 transmits one or more signals to control the operation of the lighting system 10. For example, the controller 16 transmits a signal to the power source 14 in order to selectively energize the light engine 20. The controller 16 also transmits a signal to the adjustment unit 22 to selectively control the position of the light engine 20 as described in greater detail herein. The controller 16 receives an input signal generated under the control of a user and/or generated from one or more sensors such as, but not limited to, an ambient light sensor or the like (not shown) and/or from another computer system, such as, but not limited to, a vehicle electronic control system (ECU).

Turning now to FIG. 2, a perspective view of a reflector 26 of a headlamp 12 is generally illustrated (the housing 18, adjustment unit 22, and outer lens 24 are not shown for purposes of clarity). The reflector 26 is configured to receive at least a portion of the light engine 20 and adjustment unit 22. As will be described in greater detail herein, the reflector 26 is configured to reflect light emitted by the light engine 20. As shown, the reflector 26 has a generally parabolic shape. It should be noted that the reflector 26 may include a variety of shapes and/or dimensions depending on desired light distribution.

Referring to FIG. 3, a front view of a portion of one embodiment of a headlamp consistent with the present disclosure is generally illustrated. As shown, the headlamp 12 includes a reflector 26, wherein the reflector 26 includes a first portion 28 and a second portion 30, wherein the first and second portions 28, 30 are separated from one another by a dividing plane P, wherein the dividing plane P divides the reflector 26 into the first portion 28 and the second portion 30. The first and second portions 28, 30 are configured to reflect light emitted by the light engine 20 such that the headlamp 12 projects a low-beam pattern based on light reflected from one of the first and second portions 28, 30 and projects a high-beam pattern based on light reflected from the other of the first and second portions 28, 30. This will be described in greater detail herein.

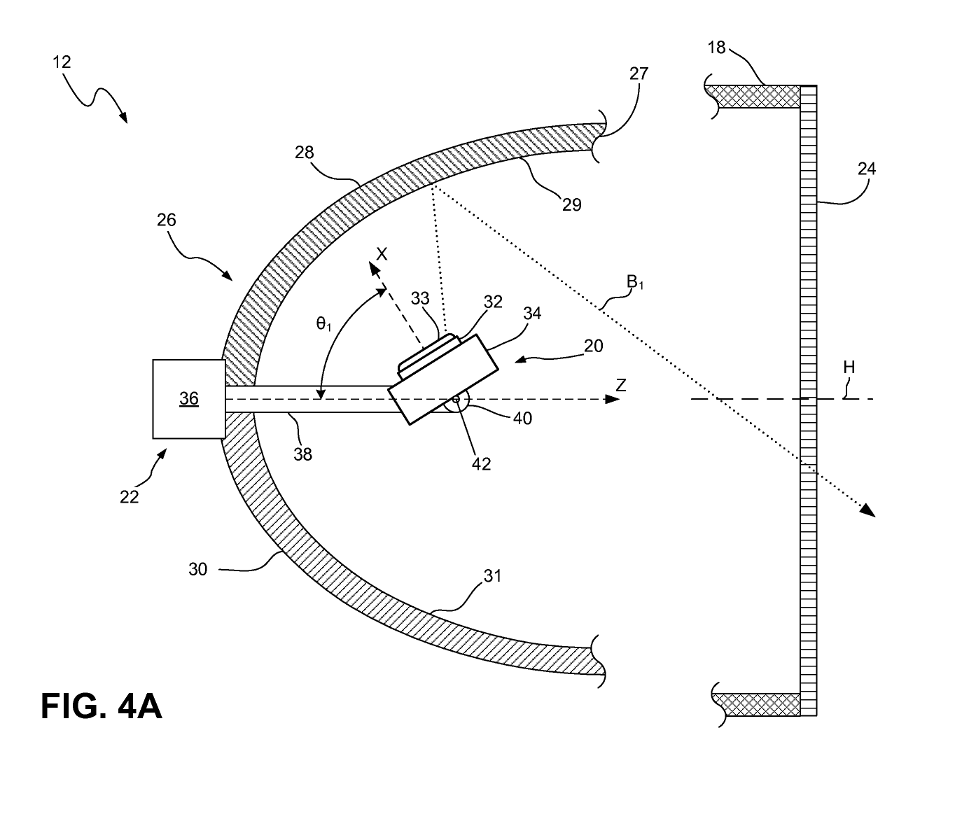

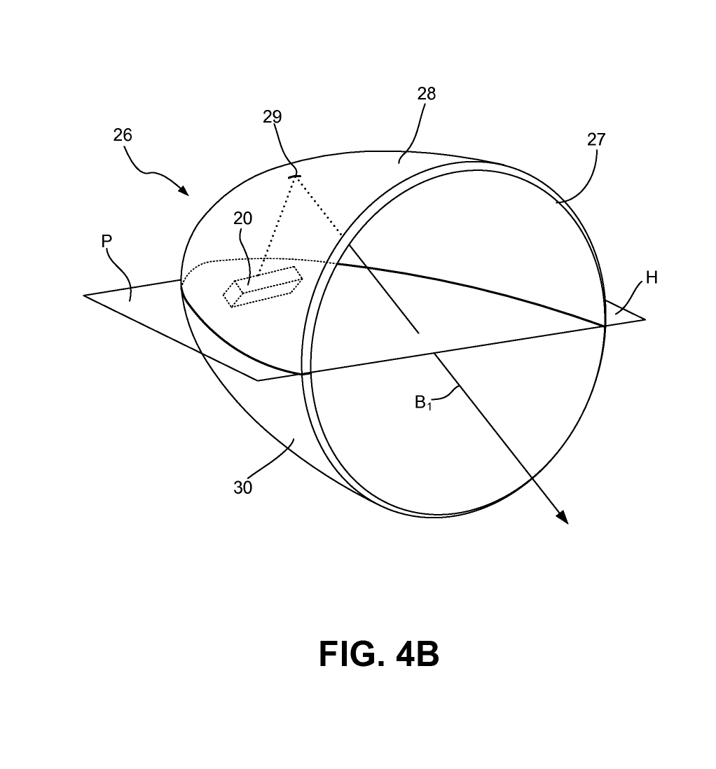

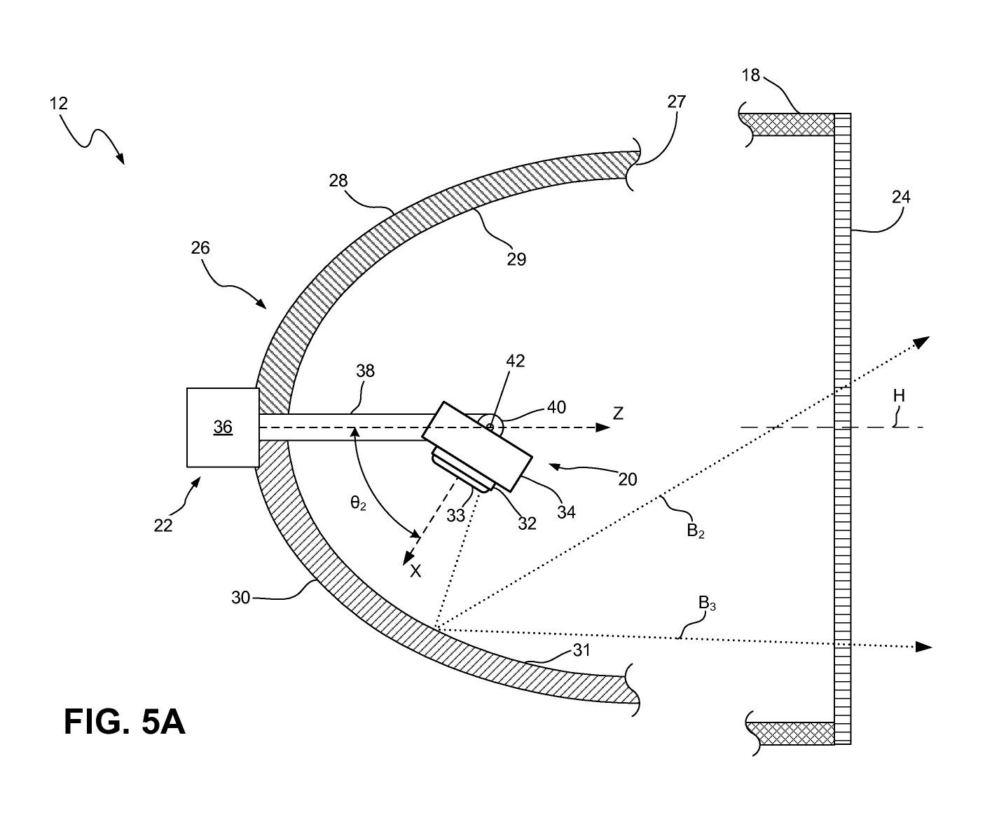

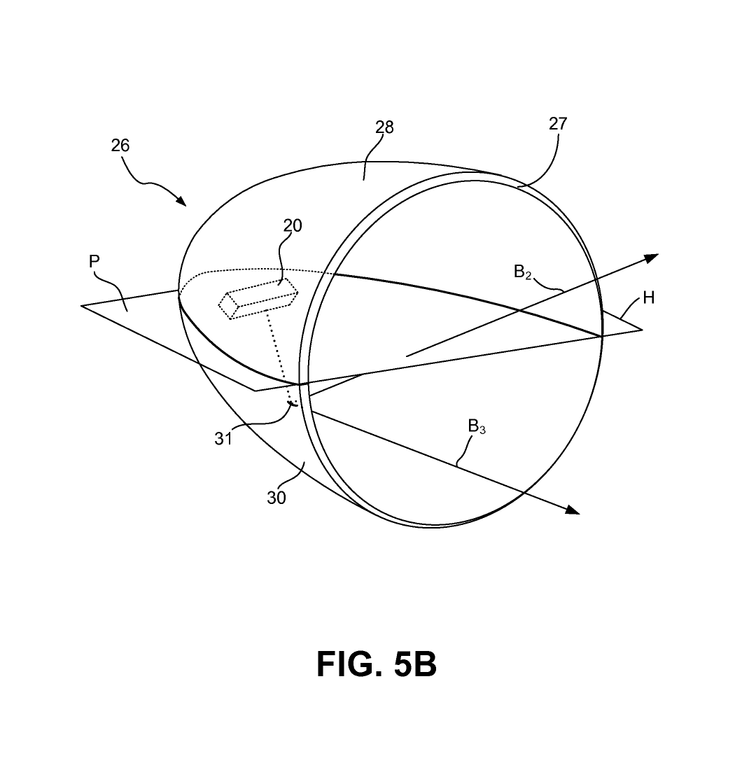

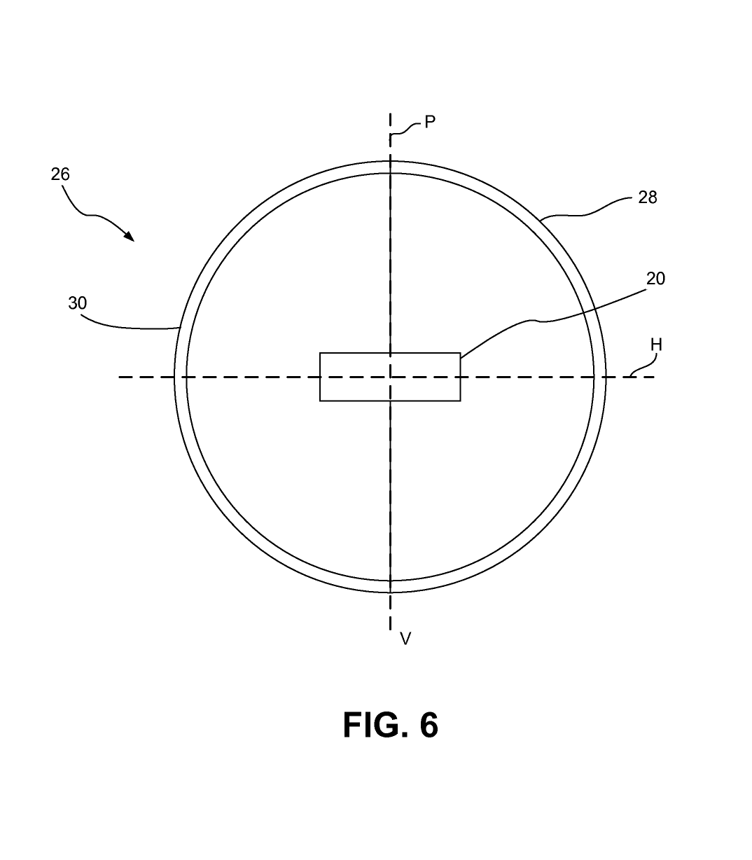

Local laws and regulations governing vehicle standards, such as Federal Motor Vehicle Safety Standards (FMVSS) and Regulations, may include specific regulations regarding the placement of low-beam and high-beam projecting portions of the headlamp. As such, depending on the region-specific laws and regulations, the mounting orientation of the headlamp 12 may vary in order to comply with such laws and regulations. For example, in the illustrated embodiment of FIGS. 3-5B, the headlamp 12 may be mounted in the chassis of a vehicle such that the dividing plane P is substantially parallel to a horizontal plane H of the vehicle along a length of the vehicle (shown in FIGS. 4B and 5B, dividing plane P and horizontal plane H share the same plane). The first portion 28 is positioned above the plane P and the second portion 30 is positioned below the plane P. In the illustrated embodiment of FIGS. 6-8B, the headlamp 12 may be mounted in a different orientation, as described in greater detail herein.

FIGS. 4A and 4B illustrate views of the headlamp 12 in a low beam mode and FIGS. 5A-5B illustrate views of the headlamp 12 in a high beam mode. As shown in FIG. 4A, the headlamp 12 includes a housing 18, a light engine 20, an adjustment unit 22 coupled to the light engine 18, and a reflector 26 configured to reflect light emitted by the light engine 20. The housing 18 is configured to receive at least a portion of the light engine 20, adjustment unit 22 and reflector 26. As shown, at least a portion of the light engine 20 and adjustment unit 22 are positioned within the reflector 26.

In the illustrated embodiment, the light engine 20 includes a solid-state light source 32, wherein the solid-state light source 32 may include a light emitting diode (LED). While the light engine 20 is illustrated as having a single solid-state light source 32, such as single LED, the light engine 20 may include multiple solid-state light sources depending on the application. For example, the light engine 20 may include a single string of multiple LEDs. The light engine 20 further includes a carrier 34 upon which the solid-state light source 32 may be positioned.

The single light engine 20 is adapted to provide a desired distribution pattern (i.e. a low beam light and a high beam light). In particular, the light engine 20 is moveable between at least a first position, as generally illustrated in FIGS. 4A-4B, to provide a low beam projection and a second position, as generally illustrated in FIGS. 5A-5B, to provide a high beam projection. While the light engine 20 is shown in two positions, it should be appreciated that the light engine 20 may also be configured to be positioned in other orientations, including, but not limited to, any position intermediate the first and second positions.

In the illustrated embodiment, the light engine 20 is coupled to the adjustment unit 22. As shown, the adjustment unit includes a support member 38 that retains the light engine 20 within the reflector 26. The adjustment unit 22 is adapted to move the light engine 20 upon receipt of a signal from the controller 16 as described herein. The adjustment unit 22 may include any device for moving the light engine 20 between the first and second positions. For example, the adjustment unit 22 may include an actuator 36, such as, for example, a solenoid and/or motor coupled to the light engine 20 through associated gearing, levers, cams, linkages, pivot arms, or the like, for displacing the light engine 20. For example, in the illustrated embodiment, the adjustment unit 22 includes a displacement member 40 coupled to the light engine 20, wherein the displacement member 40 is adapted to displace the solid-state light source 32 relative to the reflector 26 between the first position and the second position.

Referring to FIGS. 4A and 4B, one embodiment of the headlamp 12 is illustrated in the low beam mode. In particular, the controller 16 may transmit one or more signals configured to energize the light engine 20, and, in turn, the solid-state light source 32, and emit visible light from an emitting surface 33 of the solid-state light source 32 (e.g., illustrated schematically as light beams B₁). For example, the controller 16 may transmit a signal to the power source 14, which may in turn provide the necessary electrical input to the Light engine 20. The controller 16 may also transmit one or more signals to the adjustment unit 22 to arrange the light engine 20 and solid-state light source 32 in a first position. As used herein, the phrase “first position” is intended to mean that visible light emitted from the solid-state light source 32 is directed towards the first portion 28 of the reflector 26.

In response to receipt of one or more signals from the controller 16, the displacement member 40 of the adjustment unit 22 is adapted to rotate the solid-state light source 32 about an axis 42 between the first and second positions. The axis 42 is substantially perpendicular with an optical axis Z of the reflector 26 along the horizontal plane H. When the solid-state light source 32 is in the first position, an optical axis X of the solid-state light source 32 is oriented at an angle θ₁ between 0 and 90 degrees relative to the optical axis Z of the reflector 26. In one embodiment, the optical axis X of the solid-state light source 32 is oriented at an angle θ₁ between approximately 30 and 70 degrees relative to the optical axis Z of the reflector 26.

When the solid-state light source 32 is oriented in the first position, the first portion 28 of the reflector 26 is configured to receive visible light (e.g. B₁) emitted from the solid-state light source 32. An interior surface 29 of the first portion 28 is configured to redirect visible light from the solid-state light source 32 toward an open end 27 of the reflector 26, and not towards the second portion 30, such that the visible light B₁ is projected from the headlamp 12 generally below or at and below the horizontal plane H. As used herein, the phrase “below the horizontal plane H” means the visible light emitted from the headlamp 12 is emitted generally downwardly from the headlamp 12 and towards the ground and the phrase “at and below the horizontal plane H” means the visible light emitted from the headlamp 12 is emitted generally parallel to ground and/or downwardly from the headlamp 12 and towards the ground, referenced to a condition where the headlamp 12 is mounted in the vehicle.

Referring to FIGS. 5A and 5B, the headlamp 12 is illustrated in the high beam mode. In particular, in response to receipt of one or more signals from the controller 16, the displacement member 40 of the adjustment unit 22 is adapted to rotate the solid-state light source 32 about the axis 42 from the first position to the second position. As used herein, the phrase “second position” is intended to mean that visible light emitted from the solid-state light source 32 is directed towards the second portion 30 of the reflector 26. When the solid-state light source 32 is in the second position, the optical axis X of the solid-state light source 32 is oriented at an angle θ₂ between 0 and 90 degrees relative to the optical axis Z of the reflector 26. In one embodiment, the optical axis X of the solid-state light source 32 may be oriented at an angle θ₂ between approximately 30 and 70 degrees relative to the optical axis Z of the reflector 26. When the solid-state light source 32 is oriented in the second position, the second portion 30 of the reflector 26 is configured to receive visible light (e.g. illustrated schematically as light beams B₂ and B₃) emitted from the solid-state light source 32.

As shown, an interior surface 31 of the second portion 30 is configured to redirect visible light from the solid-state light source 32 toward the open end 27 of the reflector 26 and not towards the first portion 28, such that the visible light (e.g. B₂ and B₃) is projected from the headlamp 12 generally above and below the horizontal plane H. As used herein, the phrase “above and below the horizontal plane H” means the visible emitted from the headlamp 12 is emitted generally downwardly from the headlamp 12 and towards the ground (light beam B₃) and generally upwardly from the headlamp 12 and away from the ground (e.g. light beam B₂), referenced to a condition where the headlamp 12 is mounted in the vehicle.

Optionally, the headlamp 12 also includes an outer lens 24 coupled to at least a portion of the housing 18. The outer lens 24 may be provided to increase the aerodynamics of the headlamp 12. For example, the outer lens 24 may allow the headlamp 12 to aerodynamically blend in with the adjacent portions of the vehicle to reduce aerodynamic drag. The outer lens 24 may also be configured to protect components of the headlamp 12, including, but not limited to, the light engine 20, adjustment unit 22, and reflector 26. The outer lens 24 may further be configured to emit visible light reflected by the reflector 26 in one or more distribution patterns. For example, the outer lens 24 may be configured to further aid in the distribution of the visible light emitted from the headlamp 12 in either the low beam mode and/or high beam mode.

Referring to FIG. 6, a front view of a portion of another embodiment of a headlamp consistent with the present disclosure is generally illustrated. The headlamp 12 of FIGS. 6-8B is similar to the headlamp 12 of FIGS. 3-5B, and like numerals represent like parts. As previously described, depending on region-specific laws and regulations governing vehicle standards, the mounting orientation of the headlamp 12 may vary in order to comply with such laws and regulations. As shown in FIGS. 6-8B, the headlamp 12 may be mounted in the chassis of a vehicle such that the dividing plane P is substantially perpendicular to the horizontal plane H along the optical axis Z of the reflector 26, wherein the first portion 28 is positioned on one side of the dividing plane P and the second portion 30 is positioned on an opposing side of the dividing plane P.

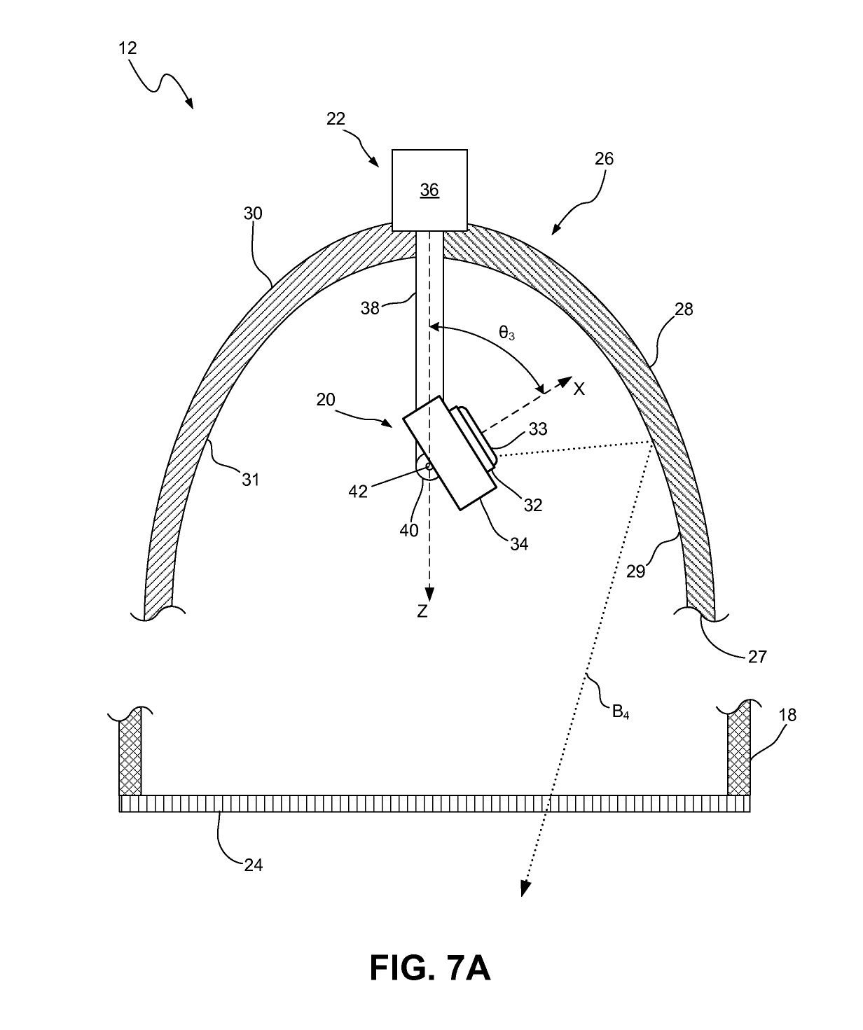

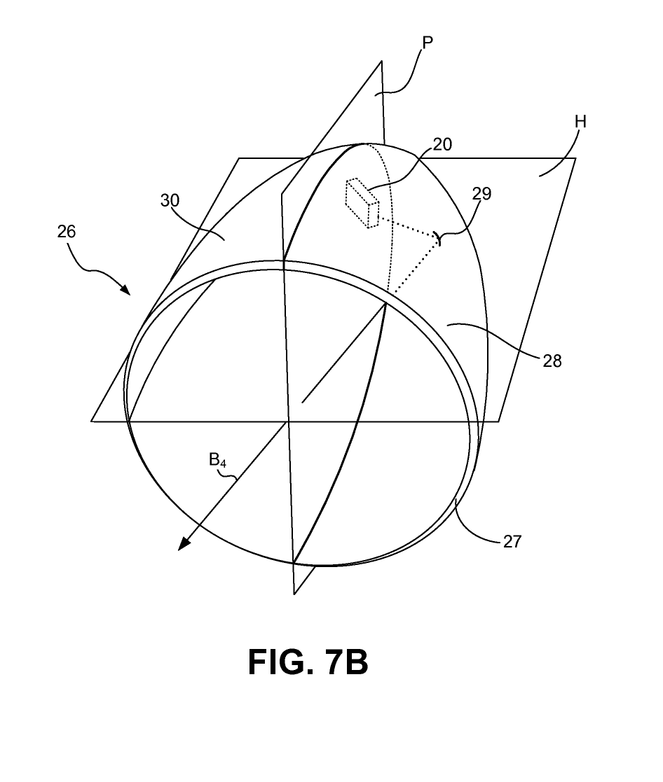

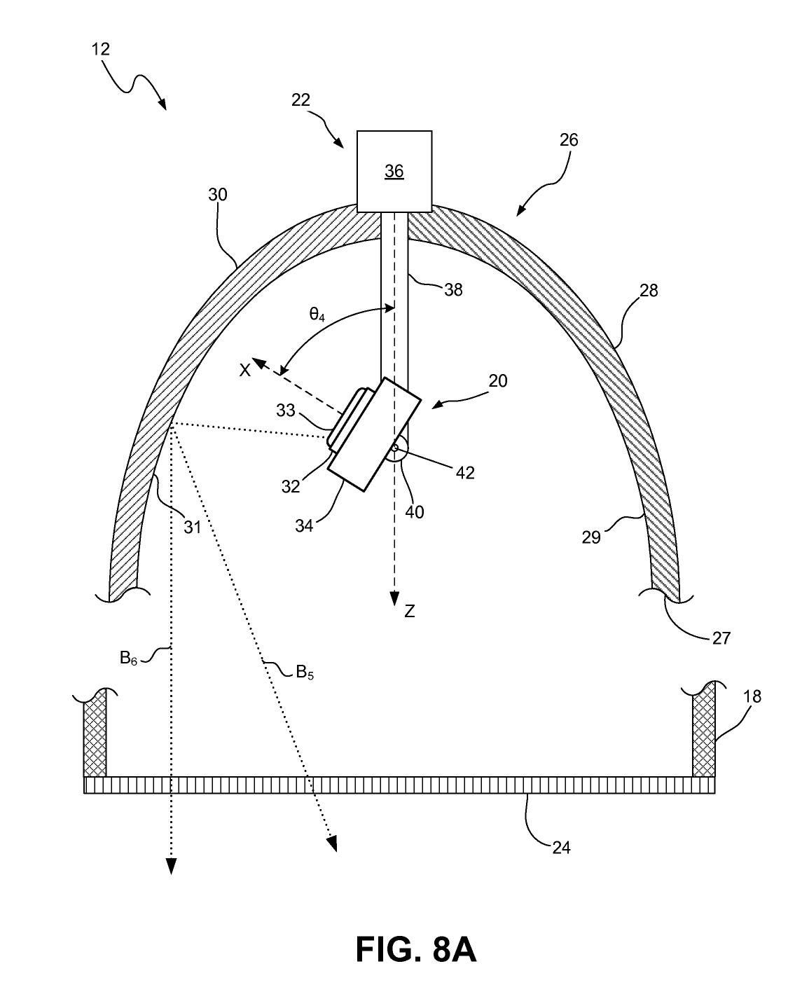

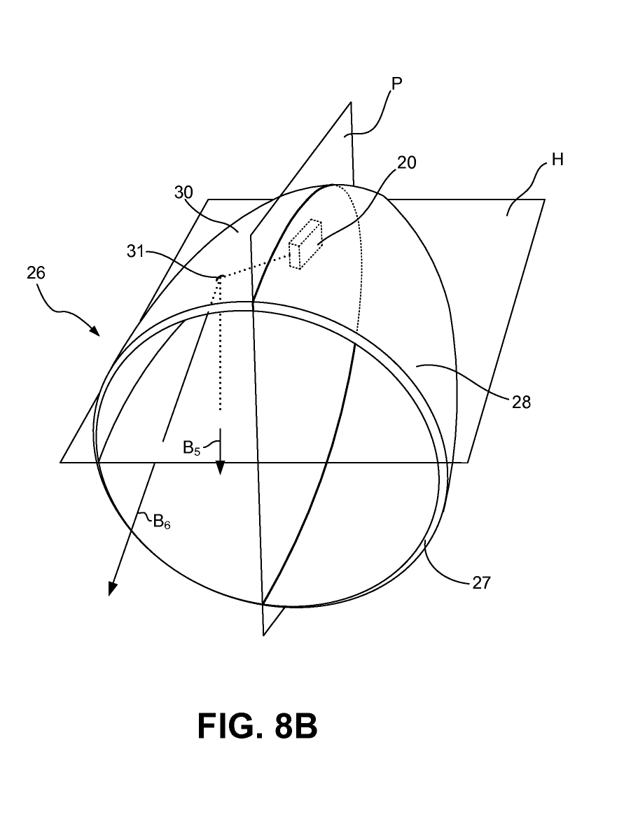

FIGS. 7A and 7B illustrate views of the headlamp 12 in a low beam mode and FIGS. 8A-8B illustrate views of the headlamp 12 in a high beam mode. In the illustrated embodiment, the single light engine 20 is adapted to provide a desired distribution pattern, such as a low beam light and a high beam light. In particular, the light engine 20 is moveable between at least a first position as generally illustrated in FIGS. 7A-7B to provide a low beam projection and a second position as generally illustrated in FIGS. 8A-8B to provide a high beam projection.

Referring to FIGS. 7A and 7B, one embodiment of the headlamp 12 is illustrated in the low beam mode. As previously described, in response to receipt of one or more signals from the controller 16, the displacement member 40 of the adjustment unit 22 is adapted to rotate the solid-state light source 32 about an axis 42 between the first and second positions. The axis 42 is substantially perpendicular to an optical axis Z of the reflector 26 and the horizontal plane H along the dividing plane P. When the solid-state light source 32 is in the first position, an optical axis X of the solid-state light source 32 is oriented at an angle θ₃ between 0 and 90 degrees relative to the optical axis Z of the reflector 26. In one embodiment, the optical axis X of the solid-state light source 32 may be oriented at an angle θ₃ between approximately 30 and 70 degrees relative to the optical axis Z of the reflector 26. When the solid-state light source 32 is oriented in the first position, the first portion 28 of the reflector 26 is configured to receive visible light (e.g. B₄) emitted from the solid-state light source 32. As shown, an interior surface 29 of the first portion 28 is configured to redirect the visible light from the solid-state light source 32 toward an open end 27 of the reflector 26 and not towards the second portion 30, such that the visible light B₄ is projected from the headlamp 12 generally below or at and below the horizontal plane H.

Referring to FIGS. 8A and 8B, the headlamp 12 is illustrated in the high beam mode. In particular, in response to receipt of one or more signals from the controller 16, the displacement member 40 of the adjustment unit 22 is adapted to rotate the solid-state light source 32 about the axis 42 from the first position to the second position. When the solid-state light source 32 is in the second position, the optical axis X of the solid-state light source 32 is oriented at an angle θ₄ between 0 and 90 degrees relative to the optical axis Z of the reflector 26. In one embodiment, the optical axis X of the solid-state light source 32 may be oriented at an angle θ₄ between approximately 30 and 70 degrees relative to the optical axis Z of the reflector 26. When the solid-state light source 32 is oriented in the second position, the second portion 30 of the reflector 26 is configured to receive visible light (e.g. illustrated schematically as light beams B₅ and B₆) emitted from the solid-state light source 32. As shown, an interior surface 31 of the second portion 30 is configured to redirect at least a portion of visible light from the solid-state light source 32 toward the open end 27 of the reflector 26 and not towards the first portion 28, such that the visible light (e.g. B₅ and B₆) is projected from the headlamp 12 generally above and below the horizontal plane H.

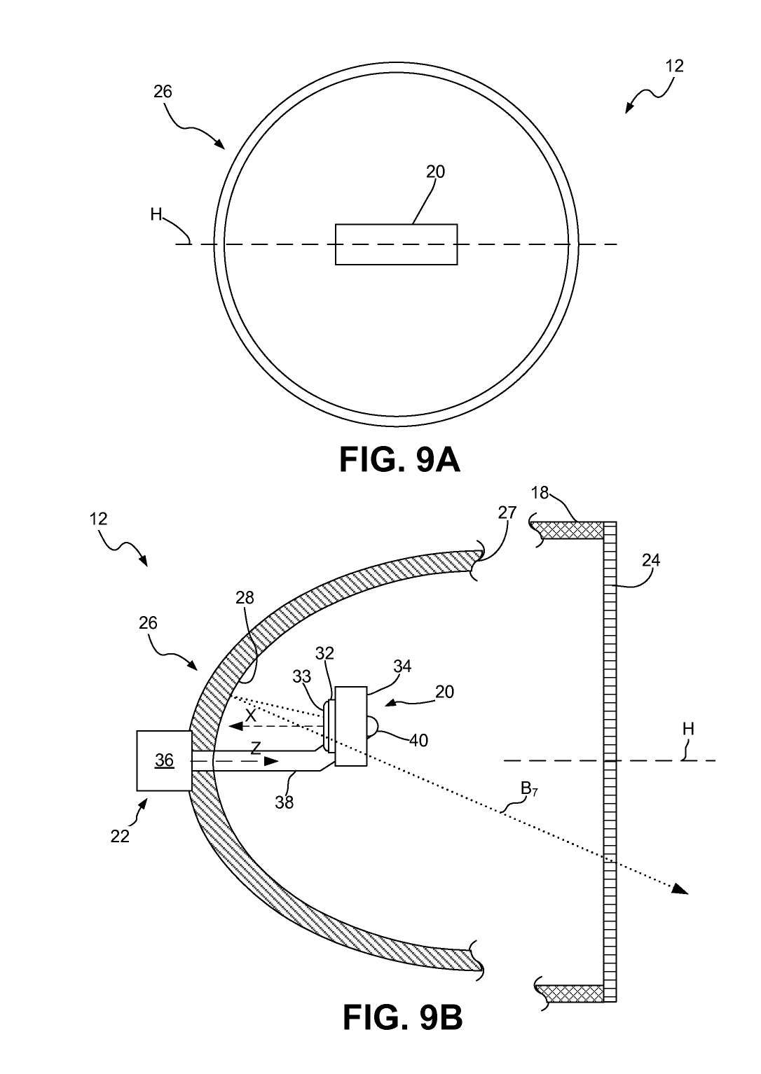

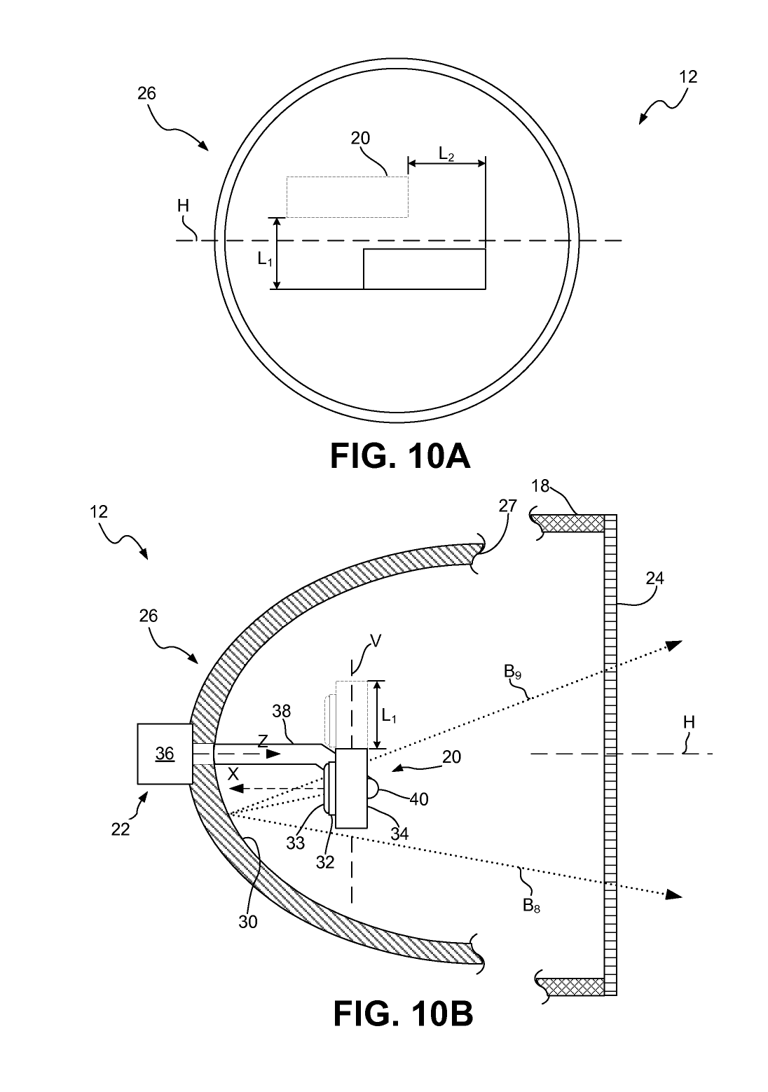

FIGS. 9A-9B and 10A-10B illustrate views of another embodiment of a headlamp in which the light source is displaced in a generally linear fashion. The headlamp 12 of FIGS. 9A-10B is similar to the headlamp 12 of FIGS. 3-5B, and like numerals represent like parts. As shown, the headlamp 12 includes a housing 18, a light engine 20, an adjustment unit 22 coupled to the light engine 18, and a reflector 26 configured to reflect light emitted by the light engine 20. The housing 18 is configured to receive at least a portion of the light engine 20, adjustment unit 22 and reflector 26. As shown, at least a portion of the light engine 20 and adjustment unit 22 are positioned within the reflector 26.

In the illustrated embodiment, the light engine 20 is moveable between at least a first position relative to the reflector 26 to provide a low beam projection, as generally illustrated in FIGS. 9A-9B, and a second position relative to the reflector 26 to provide a high beam projection, as generally illustrated in FIGS. 10A-10B. Similar to the previously described embodiments, the reflector 26 includes a first portion 28 and a second portion 30, wherein the first and second portions 28, 30 are configured to reflect light emitted by the light engine 20 such that the headlamp 12 projects a low-beam pattern based on light reflected from the first portion 28 and projects a high-beam pattern based on light reflected from the second portion 30. However, unlike the previously described embodiments, the reflector 26 of FIGS. 9A-10B is a single unitary structure.

Referring to FIGS. 9A and 9B, the headlamp 12 is illustrated in a low beam mode, wherein the light engine 20 is shown in a first position relative to the reflector 26. Similar to previous embodiments described herein, the light engine 20 includes a solid-state light source 32, wherein the solid-state light source 32 may include a light emitting diode (LED). When the light engine 20 is in the first position, an optical axis X of the solid-state light source 32 is substantially parallel to a horizontal plane H and optical axis Z of the reflector 26. When oriented in the first position, visible light (e.g. B₇) emitted from the solid-state light source 32 is imparted upon a first portion 28 of the reflector 26. The first portion 28 of the reflector 26 is configured to redirect the visible light toward an open end 27 of the reflector 26 and not towards the second portion 30, such that the visible light B₇ is projected from the headlamp 12 generally below or at and below the horizontal plane H.

Referring to FIGS. 10A and 10B, the headlamp 12 is illustrated in the high beam mode wherein the light engine 20 is shown in a second position relative to the reflector 26. Similar to previous embodiments described herein, the light engine 20 is coupled to an adjustment unit 22. The adjustment unit includes a support member 38 that retains the light engine 20 within the reflector 26. The adjustment unit 22 is adapted to move the light engine 20 from the first position to the second position upon receipt of a signal from the controller 16. The adjustment unit 22 may include any device for moving the light engine 20 between the first and second positions. For example, the adjustment unit 22 may include an actuator 36, such as, for example, a solenoid and/or motor coupled to the light engine 20 through associated gearing, levers, cams, linkages, pivot arms, or the like, for displacing the light engine 20. For example, in the illustrated embodiment, the adjustment unit 22 includes a displacement member 40 coupled to the light engine 20, wherein the displacement member 40 is adapted to displace the solid-state light source 32 relative to the reflector 26 between the first position and the second position.

In response to receipt of one or more signals from the controller 16, the displacement member 40 of the adjustment unit 22 is adapted to move the solid-state light source 32 along a vertical plane V from the first position (shown in phantom) to the second position. The vertical plane V is substantially perpendicular to the horizontal plane H. The displacement member 40 is adapted to displace the solid-state light source 32 in both vertical and horizontal directions along the vertical plane V. As shown in FIG. 10A, for example, the displacement member 40 is adapted to displace the solid-state light source 32 a length L₁ in a vertical direction and a length L₂ in a horizontal direction relative to the first position. In one embodiment, the length L₁ is between approximately 1.1 to 2 millimeters and the length L₂ is between approximately 0.1 to 5 millimeters.

When the solid-state light source 32 is in the second position, the optical axis X of the solid-state light source 32 remains substantially parallel to the horizontal plane H and optical axis Z of the reflector 26 and visible light (e.g. illustrated schematically as light beams B₈ and B₉) emitted from the solid-state light source 32 is imparted upon a second portion 30 of the reflector 26. The second portion 30 of the reflector 26 is configured to redirect the visible light toward the open end 27 of the reflector 26 and not towards the first portion 28, such that the visible light (e.g. B₈ and B₉) is projected from the headlamp 12 generally above and below the horizontal plane H.

With regard to the headlamps described herein, the first and second portions 28, 30 of the reflector 26 are configured to receive visible light from the solid-state light source 32 and redirect the visible light to produce a low-beam pattern and a high-beam pattern, respectively. The low and high-beam patterns produced by the first and second portions 28, 30 conform to current U.S. Department of Transportation (DOT) Federal Motor Vehicle Safety Standards (FMVSS) 108 specifications for the low and high-beam output of a vehicle headlamp.

The first portion 28 of the reflector 26 is shaped and/or sized to reflect visible light from the solid-state light source 32 out of the reflector 26 below or at and below the horizontal plane H and not towards the second portion 30 when the solid-state light source 32 is in the first position. The second portion 30 is shaped and/or sized to reflect the visible light out of the reflector 26 above and below the horizontal plane H and not towards the first portion 28 when the solid-state light source 32 is in the second position. As such, a headlamp consistent with the present disclosure does not require a shield, also known as a “Graves Shield”, to aid in production of the low-beam pattern. More specifically, some current headlamps, when in low-beam mode, require a shield to block any stray light that would otherwise strike the high-beam portion of the reflector and be cast (i.e. reflected) above the horizontal plane. Accordingly, a headlamp consistent with the present disclosure requires less components, which may reduce manufacturing costs.

The shapes of the first and second portions 28, 30 may include, but are not limited to, known parabolic, elliptical and sphero-elliptical configurations including those with faceted interior surfaces as well as truncated reflector cups. The phrase “truncated reflector cup” means a portion of a reflector cup, as may be realized, for example, by dividing a reflector cup along a plane intersecting the longitudinal axis (e.g., intersecting a first end and a second end). A truncated reflector may thus be configured as one-half of a reflector cup, but may be more or less than half of a reflector cup. For example, a truncated reflector cup may have a semi-parabaloid or semi-ellipsoid shape.

As generally understood by one of ordinary skill in the art, the first and second portions 28, 30 may include parametric and/or non-parametric surface definition types including, but not limited to, non-uniform rational basis spline (NURBS) curves and/or surfaces configured to reflect the light received from the solid-state light source 32 in the desired pattern (i.e. low-beam and high-beam patterns). Commercially available software including, but not limited to, computer-aided design (CAD), computer-aided manufacturing (CAM), and computer-aided engineering (CAE) software, may be used for the design of NURBS curves and/or surfaces of the first and second portions 28, 30. For example, a reflector consistent with the present disclosure may be designed using LucidShape computer-aided lighting software offered by Brandenburg GmbH (Paderbom, Germany).

The reflector 26 may be selected to have a high reflectivity. For example, the reflector 26 may have a reflectivity equal to or greater than 85%. According to one embodiment, the reflector 26 may include a metal (such as, but not limited to, aluminum, copper, silver, gold, or the like), metal alloys, plastics (e.g., but not limited to, doped plastics), as well as composites. It should be appreciated that the arrangement, shape and/or contour of the light engine 20, adjustment unit 22, and the reflector 26 will depend on the specific application of the headlamp 12 and may include (but is not limited to) such factors as the overall size constraints on the headlamp 12, desired aesthetic appearance of the headlamp 12, as well as the desired luminosity of the headlamp 12.

Accordingly, consistent with one embodiment of the present disclosure, an automotive headlamp 12 is provided. The automotive headlamp 12 includes a light engine 20 including a solid-state light source 32 emitting visible light and a reflector 26 configured to receive and reflect light emitted by the solid-state light source 32. The automotive headlamp 12 further includes an adjustment unit 22 having a displacement member 40 coupled to the solid-state light source 32 and adapted to displace the solid-state light source 32 relative to the reflector 26 between a first position, wherein the light from the solid-state light source 32 is directed towards a first portion 28 of the reflector 26, and a second position, wherein the light from the solid-state light source 32 is directed towards a second portion 30 of the reflector 26. When the solid-state light source 32 is in the first position, the headlamp 12 projects a low-beam pattern based on light reflected by the first portion 28 of the reflector 26. When the solid-state light source 32 is in the second position, the headlamp 12 projects a high-beam pattern based on light reflected by the second portion 30 of the reflector 26.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

While the principles of the present disclosure have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

The following is a list of reference numeral used in the specification:
10 lighting system
12 light module
14 power source
15 ballast
16 controller
18 housing
20 light engine
22 adjustment unit
24 outer lens
26 reflector
27 open end of reflector
28 first portion of reflector
29 interior surface of first portion of reflector
30 second portion of reflector
31 interior surface of second portion of reflector
32 solid-state light source
33 emitting surface of solid-state light source
34 carrier for solid-state light source
36 actuator
38 support member
40 displacement member
42 axis about which light source rotates
θ₁-θ₄ angles between optical axes of solid-state light source and reflector
B₁-B₉ light beams
H horizontal plane
L₁-L₂ length of movement of light engine
P dividing plane
V vertical plane
X optical axis of solid-state light source
Z optical axis of reflector

What is claimed is:

1. An automotive headlamp (12) comprising:
a light engine (20) comprising a solid-state light source (32) emitting visible light;
a reflector (26) configured to receive and reflect light emitted by said solid-state light source (32); and
an adjustment unit (22) having a displacement member (40) coupled to said solid-state light source (32) and adapted to displace said solid-state light source (32) relative to said reflector (26) between a first position, wherein said light from said solid-state light source (32) is directed towards a first portion (28) of said reflector (26), and a second position, wherein said light from said solid-state light source (32) is directed towards a second portion (30) of said reflector (26);
wherein, when said solid-state light source (32) is in said first position, said headlamp (12) projects a low-beam pattern based on light reflected by said first portion (28) of said reflector (26), and when said solid-state light source (32) is in said second position, said headlamp (12) projects a high-beam pattern based on light reflected by said second portion (30) of said reflector (26).

2. The automotive headlamp of claim 1, wherein said solid-state light source (32) comprises at least one light emitting diode (LED) light source.

3. The automotive headlamp of claim 1, wherein said adjustment unit (22) is configured to receive input from a controller (16), whereby said displacement member (40) is adapted to rotate said solid-state light source (32) about an axis (42) between said first position and said second position in response to input from said controller (16).

4. The automotive headlamp of claim 3, wherein said axis (42) is substantially perpendicular to an optical axis (Z) along a dividing plane (P) dividing said reflector (26) into said first portion (28) and said second portion (30).

5. The automotive headlamp of claim 4, wherein an optical axis (X) of said solid-state light source (32) is oriented at an angle θ₁ between 0 and 90 degrees relative to said optical axis (Z) of said reflector (26) when said solid-state light source (32) is in said first position.

6. The automotive headlamp of claim 4, wherein an optical axis (X) of said solid-state light source (32) is oriented at an angle θ₂ between 0 and 90 degrees relative to said optical axis (Z) of said reflector (26) when said solid-state light source (32) is in said second position.

7. The automotive headlamp of claim 1, wherein said adjustment unit (22) is configured to receive input from a controller (16), whereby said displacement member (40) is adapted to translate said solid-state light source (32) between said first position and said second position in response to input from said controller (16).

8. The automotive headlamp of claim 1, wherein said adjustment unit (22) comprises a solenoid actuator.

9. A lighting system (10) comprising the headlamp (12) of claim 1 and further comprising:
a power source (14) for supplying electrical input to said light engine (20) and said adjustment unit (22); and
a controller (16) coupled to said adjustment unit (22) and adapted to selectively energize said adjustment unit (22) to displace said solid-state light source (32) between said first and said second positions.

10. The automotive headlamp of claim 1, wherein said low-beam pattern comprises visible tight emitted generally below or at and below a horizontal plane (H) and wherein said high-beam pattern comprises visible light emitted generally above and below said horizontal plane (H).
